(19) United States
(12) Patent Application Publication
(10) Pub. No.: US 2025/0218017 A1
(43) Pub. Date: Jul. 3, 2025

(54) DEFECT DEPTH ESTIMATION FROM BORESCOPE IMAGERY

(71) Applicant: RTX Corporation, Farmington, CT (US)

(72) Inventors: Kin Gwn Lore, Belmont, MA (US); Ozgur Erdinc, Mansfield, CT (US); Amit Surana, Newington, CT (US); Peter Warren Hill-Ricciuti, Torrington, CT (US)

(21) Appl. No.: 18/491,300

(22) Filed: Oct. 20, 2023

(51) Int. Cl. G06T 7/579; G06T 7/00; G06T 7/246

(52) U.S. Cl. CPC G06T 7/579; G06T 7/0002; G06T 7/248; G06T 2207/10016; G06T 2207/10068; G06T 2207/20081

(57) ABSTRACT

A defect depth estimation system includes a training system and an imaging system that performs defect depth estimation from a monocular 2D image without using a depth sensor. The training system repeatedly receives a first type of image having a defect, and a second type of image that captures the target object having the defect and provides ground truth data indicating an actual depth of the defect. The training system transforms the first domain and the second domain into a target third domain that reduces a domain gap and trains a machine learning model to learn the actual depth of the defect using the target third domain. The imaging system receives a 2D test image in the first forma and uses the trained machine learning model to determine an estimation of the actual depth of the actual defect and to output estimated the estimation of the actual depth.

### STATEMENT OF FEDERAL SUPPORT

This invention was made with Government support under Contract FA8650-21-C-5254 awarded by the United States Air Force. The Government has certain rights in the invention.

### BACKGROUND

As is known, optical instruments are available to assist in the visual inspection of inaccessible regions of objects. An egocentric camera such as a borescope, for example, includes an image sensor coupled to an optical tube which can be located in hard-to-reach areas to allow a person at one end of the tube to view images (i.e., pictures/videos) acquired at the other end. Thus, egocentric cameras typically include a rigid or flexible tube having a display on one end and a camera on the other end, where the display is linked to the camera to display images (i.e., pictures/videos) taken by the camera.

### BRIEF DESCRIPTION

According to a non-limiting embodiment, a defect depth estimation system includes a training system and an imaging system configured to perform defect depth estimation from a monocular two-dimensional image without using a depth sensor. The training system is configured to repeatedly receive a plurality of training image sets, where each training image set includes a first type of image having a first image format and capturing a target object having a defect, and a second type of image having a second image format different from the first image format. The second type of image captures the target object having the defect and provides ground truth data indicating an actual depth of the defect. The first image format defines a first domain and the second image format defines a second domain different from the first domain such that the difference between the first domain and the second domain defines a domain gap. The training system is further configured to perform at least one domain adaption technique on the first and second images that transforms the first domain and the second domain into a target third domain that reduces the domain gap, and is configured to train a machine learning model to learn the actual depth of the defect using the first and second images having the target third domain. The imaging system is configured to receive a two-dimensional (2D) test image in the first format that captures a test object having an actual defect with an actual depth, and to process the 2D test image using the trained machine learning model to determine an estimation of the actual depth of the actual defect, Accordingly, the imaging system is configured to output from the trained machine learning model estimated depth information indicating the estimation of the actual depth.

In addition to one or more of the features described above, or as an alternative to any of the foregoing embodiments, the 2D test image is generated by an image sensor that captures the test object in real-time.

In addition to one or more of the features described above, or as an alternative to any of the foregoing embodiments, the 2D test image is captured by a borescope.

In addition to one or more of the features described above, or as an alternative to any of the foregoing embodiments, the first type of image is a two-dimensional (2D) video image and the second type of image is an ACI image.

In addition to one or more of the features described above, or as an alternative to any of the foregoing embodiments, the at least one domain adaption technique includes at least one of feature-based domain adaptation, instance-based domain adaptation, model-based domain adaptation, sub-space alignment, and Fourier domain adaptation (FDA).

In addition to one or more of the features described above, or as an alternative to any of the foregoing embodiments, the estimated depth information includes at least one of an estimated depth scalar value of the actual depth and an estimated depth map of the actual depth.

According to another non-limiting embodiment, a defect depth estimation system comprises an image sensor and a processing system. The image sensor is configured to generate at least one 2D test image of a test object existing in real space and having a defect with a depth. The processing system is configured to input the at least one 2D test image to a trained machine learning model and to output estimated depth information indicating an estimation of the depth of the defect.

According to another non-limiting embodiment, a method performs defect depth estimation from a monocular two-dimensional (2D) image without using a depth sensor. The method comprises repeatedly inputting a plurality of training image sets to a training system, each training image set comprising a first type of image having a first image format defining a first domain and capturing a target object having a defect, and a second type of image having a second image format different from the first image format and defining a second domain. The method further comprises capturing, by the training system, the target object having the defect, the second image data providing ground truth data indicating an actual depth of the defect such that the difference between the first domain and the second domain defines a domain gap. The method further comprises performing, by the training system, at least one domain adaption technique on the first and second images that transforms the first domain and the second domain into a target third domain that reduces the domain gap. The method further comprises training, by the training system, a machine learning model to learn the actual depth of the defect using the first and second images having the target third domain. The method further comprises inputting to an imaging system, a two-dimensional (2D) test image in the first format that captures a test object having an actual defect with an actual depth. The method further comprises processing, by the imaging system, the 2D test image using the trained machine learning model to determine an estimation of the actual depth of the actual defect, and to output from the trained machine learning model estimated depth information indicating the estimation of the actual depth.

### BRIEF DESCRIPTION OF THE DRAWINGS

The following descriptions should not be considered limiting in any way. With reference to the accompanying drawings, like elements are numbered alike:

FIG. 1 is a visual representing illustrating a method for mapping a defect of an object onto a computer-aided design (CAD) model using a 2D borescope inspection video;

FIG. 2 illustrates an imaging system configured to perform defect depth estimation from a monocular two-dimensional image without using a depth sensor according to non-limiting embodiment of the present disclosure;

FIG. 3 depicts an training system that utilizes a multi-step training methodology to train an artificial intelligence machine learning (AIML) algorithm/model capable of performing defect depth estimation from a monocular two-dimensional image without using a depth sensor according to non-limiting embodiment of the present disclosure;

FIG. 4 depicts an training system that utilizes a single-step training methodology to train an artificial intelligence machine learning (AIML) algorithm/model capable of performing defect depth estimation from a monocular two-dimensional image without using a depth sensor according to non-limiting embodiment of the present disclosure;

FIG. 5 depicts a testing operation performed using a depth estimation model according to a non-limiting embodiment according to a non-limiting embodiment of the present disclosure;

FIG. 6 depicts a training system that utilizes a semi-supervised learning scheme to train an autoencoder and a classifier/regressor supervised model to perform depth estimation of a defect according to a non-limiting embodiment of the present disclosure; and

FIG. 7 depicts a computing system configured to perform defect depth estimation based on an object in motion according to a non-limiting embodiment of the present disclosure.

### DETAILED DESCRIPTION

A detailed description of one or more embodiments of the disclosed apparatus and method are presented herein by way of illustration and not limitation with reference to the Figures.

Optical instruments may be used for many applications, such as the visual inspection of aircraft engines, industrial gas turbines, steam turbines, diesel turbines and automotive/truck engines to defect defects. Many of these defects such as oxidation defects and spallation defects have a depth, which is of interest because it can provide information as to the severity of the defect and/or how substantial the defect may affect the defective component.

While depth estimation can be done if the optical instrument provides RGB/monochrome images and depth modality, many standard optical instruments lack a depth sensor to provide depth information to ease alignment. However, implementing a depth sensor adds expense and cost to the optical instrument. In addition, the depth sensor can be damaged when locating the optical instrument in volatile inspection areas (e.g., high heat and/or high traffic areas).

Various approaches have been developed to detect engine defects. One approach includes performing several sequences of mapping a defect onto a computer-generated image or digital representation of the object of such as, for example, a CAD model of the object having the defect.

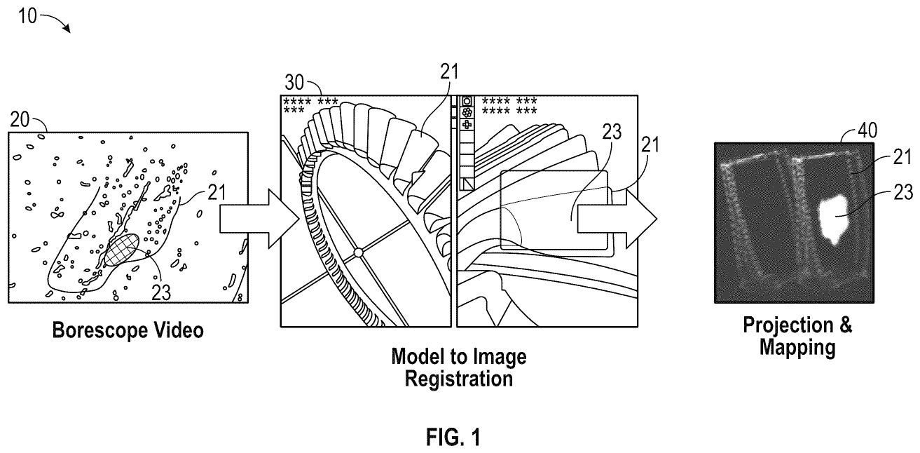

Turning to FIG. 1, for example, a method 10 of mapping a defect of an object onto a CAD model is illustrated. The method 10 includes using an egocentric camera (i.e., a borescope) to obtain a two-dimension (2D) video of an object 21 and performing visual analytics 20 to detect defects in the object. The images of the borescope video are aligned with the CAD model 30 based on the observed (i.e., inferred) object 21 and the projected detected defects 23 from the images 20 are mapped to the CAD model 40, which is then digitized. Unfortunately, digitizing identified defects 23 is a challenge due lack of accurate depth estimation.

While depth estimation may be performed for RGB/monochrome images and depth modality, the obtained image datasets typically lack sufficient depth sensor data to provide depth information to ease alignment. In addition, CAD models need to be registered to the image/video frame, so that any visual detections can be projected onto the CAD model for digitization. Using an egocentric camera (i.e., a borescope) also makes it challenging to register the CAD model to the observed scene due to the permanent occlusion and the small field of view.

Existing defect detection machine learning (ML) frameworks need large amounts of labeled training data (e.g. key points on images for supervised training via deep learning). As such, unsupervised defect detection schemes are desired, but current methods are limited to certain extents (e.g. fitting silhouette of CAD/assembly model over the segmented images). Moreover, current defect detection methods are not always feasible due to clutter, environmental variations, illumination, transient objects, noise, etc., and a very small field-of-view.

Non-limiting embodiments of the present disclosure address the aforementioned shortcomings of currently available optical instruments by providing a defect depth estimation system configured to estimate a depth of defect included in an inspected part based on images provided from an optical instrument. In a first embodiment, the defect depth estimation system utilizes supervised learning that leverage optical instrument images, ACI imageries, and an associated ground truth (ACI measurements, white light/blue light depth scans, etc.) to learn a model that directly infers depth of defects from input images.

In a second embodiment, the defect depth estimation system estimates the depth of a defect by exploiting a temporal nature of the video frames. In particular, the defect depth estimation system analyzes consecutive frames to understand the 3D structure of the defect, and in turn subsequently estimate the depth of the defect.

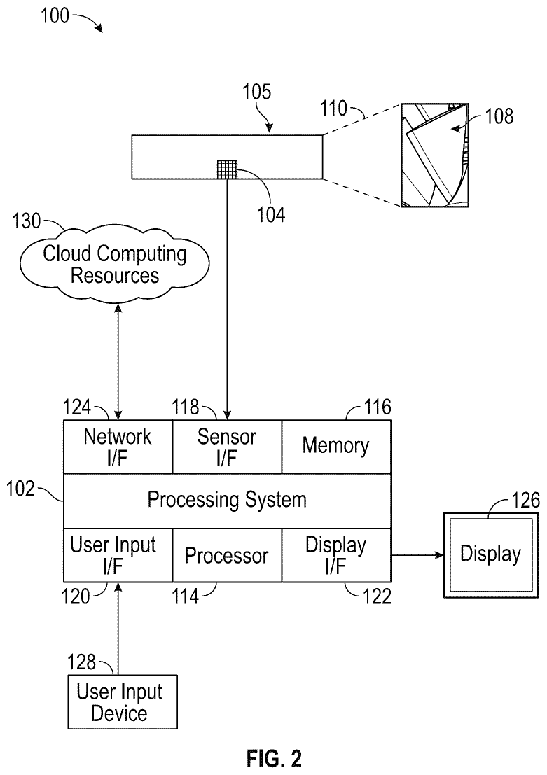

Referring now to FIG. 2, an imaging system 100 is illustrated which includes a processing system 102 and an image sensor 104. The image sensor 104 can be implemented in an optical instrument 105, for example, which can analyze one or more test objects 108 appearing within a field of view (FOV) 110. The optical instrument 105 includes, but is not limited to, a borescope, an endoscope, a fiberscope, a videoscope, or other various known inspection cameras or optical instruments that generate 2D monocular images and/or video frames without using a depth sensor. The test object 108 described herein is an aircraft turbine blade, for example, but it should be appreciated that the image sensor 104 described herein can analyze other types of test objects 108 without departing from the scope of the invention.

The processing system 102 includes at least one processor 114, memory 116, and a sensor interface 118. The processing system 102 can also include a user input interface 120, a display interface 122, a network interface 124, and other features known in the art. The image sensors 104 are in signal communication with the sensor interface 118 via wired and/or wireless communication. In this manner, pixel data output from the image sensor 104 can be delivered to the processing system 102 for processing.

The processor 114 can be any type of central processing unit (CPU), or graphics processing unit (GPU) including a microprocessor, a digital signal processor (DSP), a microcontroller, an application specific integrated circuit (ASIC), a field programmable gate array (FPGA), or the like. Also, in embodiments, the memory 116 may include random access memory (RAM), read only memory (ROM), or other electronic, optical, magnetic, or any other computer readable medium onto which is stored data and algorithms as executable instructions in a non-transitory form.

The processor 114 and/or display interface 122 can include one or more graphics processing units (GPUs) which may support vector processing using a single instruction multiple data path (SIMD) architecture to process multiple layers of data substantially in parallel for output on display 126. The user input interface 120 can acquire user input from one or more user input devices 128, such as keys, buttons, scroll wheels, touchpad, mouse input, and the like. In some embodiments the user input device 128 is integrated with the display 126, such as a touch screen. The network interface 124 can provide wireless and/or wired communication with one or more remote processing and/or data resources, such as cloud computing resources 130. The cloud computing resources 130 can perform portions of the processing described herein and may support model training.

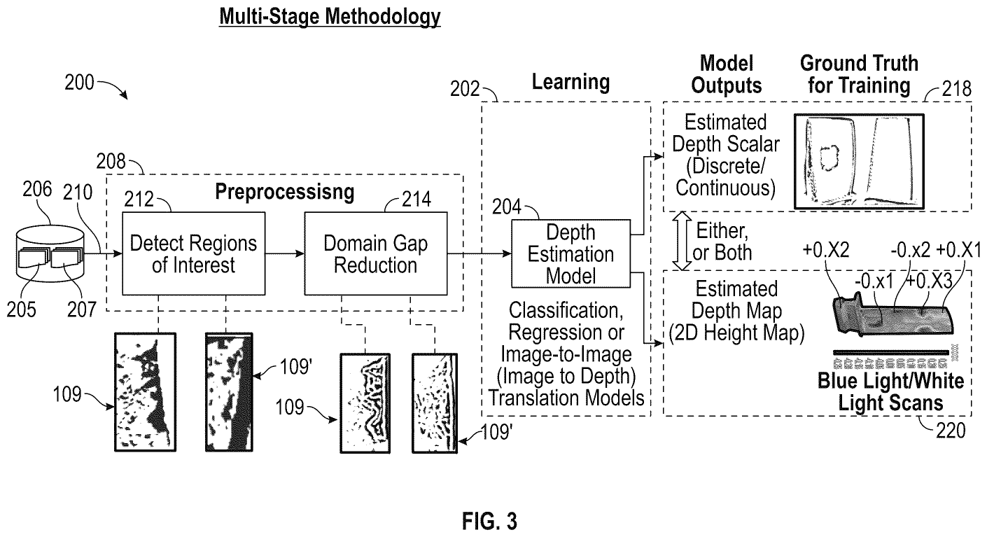

Turning to FIG. 3, a training system 200 configured to train an artificial intelligence machine learning (AIML) depth estimation model 204 capable of estimating depths of a defect included in an inspected object is illustrated according to non-limiting embodiment of the present disclosure. The training system 200 can be established as a supervised learning training system, for example, which can analyze and process labeled data to train the AIML depth estimation model 204. In one or more non-limiting embodiments, the training system 200 can be performed as part of an off-line process using a separate processing system. Alternatively, the processing system 102 can be configured in a training phase to implement the training system 200 of FIG. 3. The example illustrated in FIG. 3 can be referred to as a multi-stage training methodology. For each input image, the training system 200 analyzes the object in the image, identifies a defect in the object, extracts a region of interest containing the defect, and estimates depth of the defect as represented by an estimated scalar value or a depth-map.

With continued reference to FIG. 3, a data source 206 provides training data to develop an AIML depth estimation model 204 after preprocessing 208 is performed. The training data in data source 206 can originate from data captured by an optical instrument 105, (e.g., implementing image sensor 104 shown in FIG. 2) for example, during a training phase. The training data can include real analytical condition inspection (ACI) imagery data captured with known ground truths 205 and real video data 207 with known ground truths. As described herein, the ACI imageries include images where parts or objects commonly targeted for inspection are positioned under controlled environment (e.g. lab environment, fixed position, clear lighting/illumination, etc.) to reveal defects clearly. In this manner, the ACI images can be used for more accurate inspection for creating high quality ground truths. The ACI imagery data can be captured using an optical instrument that generates 2D monocular images without using a depth sensor. In one or more non-limiting embodiments, the ACI imagery data is associated with an ACI report that provides depth information of a particular defect included in the captured object such that the ACI imagery data can be used as ground truth data when training the AIML depth estimation model 204. The real video data 207 can be captured using a borescope, for example, which generates 2D monocular video frames without using a depth sensor. The 2D monocular images and/or video frames can include, for example, RGB video images of objects (e.g., turbine blade 108).

As part of preprocessing 208, the training system 200 can include a region-of-interest detector 212, and a domain gap reduction unit 214. Image data 210 or frame data 210 included in the training data 205 can be provided to the region-of-interest detector 212, which may perform edge detection or other types of region detection known in the art. In one or more non-limiting embodiments, the region-of-interest detector can also detect patches (i.e., areas) of interest based on the regions of interest identified by the region-of-interest detector 212 as part of preprocessing 208.

The domain gap reduction unit 214 performs various processes that reduces the domain gap between the real images provided by the image sensor 104 (e.g., ACI imagery 205 and real RGB video images 207). A low domain gap indicates that the data distribution in the target domain is relatively similar to that of the source domain. When there is a low domain gap, the AIML depth estimation model 204 is more likely to generalize effectively to the target domain. When utilizing both ACI imagery and video frame data (e.g., borescope imagery), however, a large domain gap exists because the ACI imagery 205 and the real video data 207 appear different from one another. Therefore, the domain gap reduction unit 214 can perform one or more domain adaption processes to convert the extracted region of interest 109 included in the ACI imagery 205 and the extracted region of interest 109′ real video data 207 (e.g., a 2D video stream, one or more 2D vide frames etc.) into a common representation space so as to reduce the domain gap. The domain adaptation processes utilized by the domain gap reduction unit 214 include, but are not limited to, feature-based domain adaptation, instance-based domain adaptation, model-based domain adaptation, sub-space alignment, and Fourier domain adaptation (FDA).

According to a non-limiting embodiment, the real video data 207 (e.g., 2D video frame) may include a first region of interest 109′ and the ACI imagery 205 may include a second region of interest 109. The domain gap reduction unit 204 can operate to bring the image of the first region of interest 109′ to a first converted domain and the image of the second region of interest 109 to a second converted domain. Training can then be performed using only a single modality in a common domain, using the first converted domain of the first region of interest 109′ and the second converted domain of the second region of interest 109 as an independent input. Learning is possible in this case because they are in the similar/common domain.

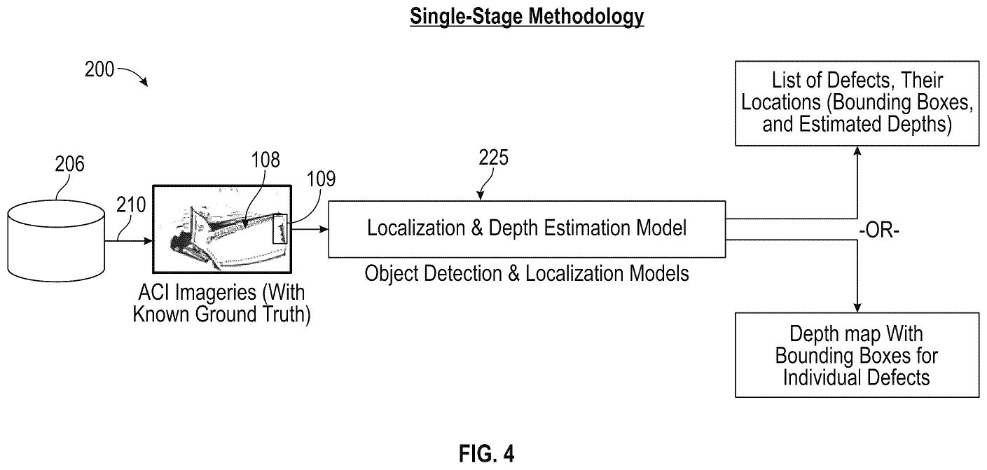

In another non-limiting embodiment shown in FIG. 4, the training system 200 can be implemented as a single-stage training methodology. In this example, the training system 200 employs a localization and depth estimation model 225. Unlike the multi-step training methodology, which literally performs multiple-steps (e.g., region of interest extraction, inputting the image of the defect at the region of interest into the model, and estimating the depth using the depth estimation model) one input image at a time, the localization and depth estimation model 225 can input several images 109 at once, and then simultaneously output: (1) a list of all detected defects, the locations of the defects in the respective images, and the estimated depths for each of the defects; and/or (2) a depth map with bounding boxes for all individual defects in their respective input images.

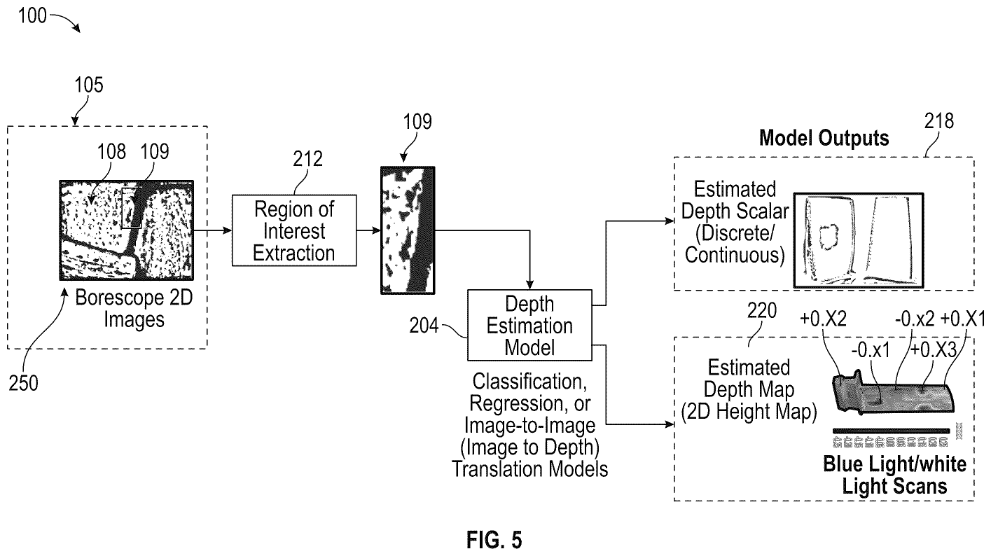

Turning to FIG. 5, a testing operation performed using the depth estimation model 204 is illustrated according to a non-limiting embodiment. Although FIG. 5 implements the depth estimation model 204 trained according to the multi-stage training system 200 shown in FIG. 3, it should be appreciated that the 225 trained according to the single-stage training system 200 shown in FIG. 4 can be utilized without departing from the scope of the present disclosure.

In FIG. 5, a real two-dimensional image 250 for testing is obtained from an optical instrument 105 (e.g., a borescope). The test image 250 captures an object 108 under inspection, which is subsequently processed through the region of interest extractor 212. The region of interest extractor identifies and isolates a region of interest 109 containing a defect in the object 108 captured in the real two-dimensional image 250. This region of interest 109, now featuring the defect, is then directed into the trained depth estimation model 204. The depth estimation model 204, having been trained on suitable data described herein, leverages its learned knowledge to estimate the depth of the detected defect. The depth estimation is provided in the form of either estimated depth scalars (e.g., scalar numerical value) 218, which may be discrete or continuous, and/or an estimated depth map (i.e., a depth map imagery ranging from a minimum depth e.g., −0.×2 to a maximum depth e.g., +0.×3) 220, offering a comprehensive representation of the defect's depth characteristics (e.g., an estimation of the defect's depth).

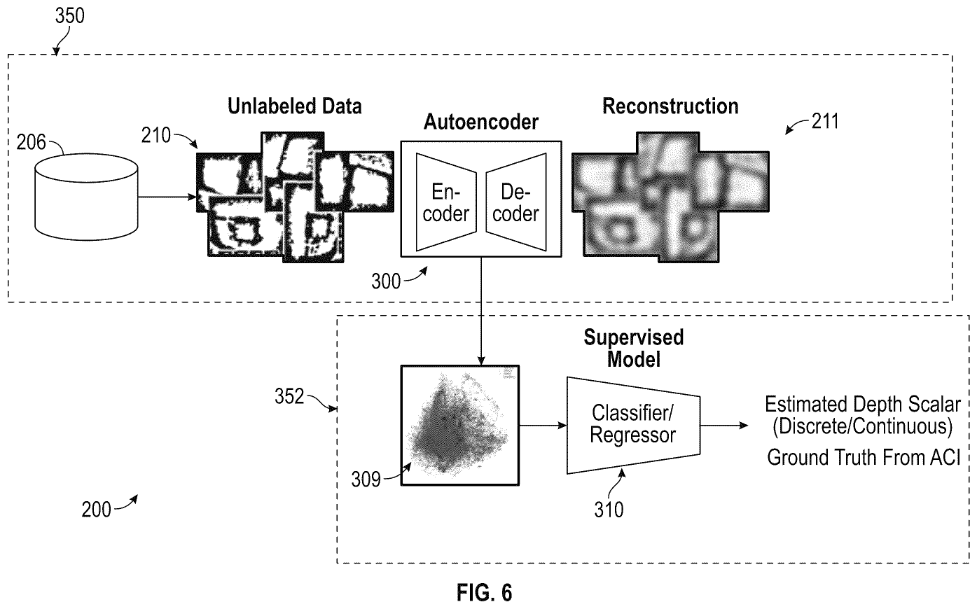

Referring now to FIG. 6, one or more non-limiting embodiments provides a training system 200 that utilizes a semi-supervised learning scheme to train an autoencoder 300 (e.g., encoders/decoders) and a classifier/regressor supervised model 310 which serves as a depth estimation model. The training system 200 includes an unsupervised training pipeline 350 and a supervised training pipeline 352.

The unsupervised training pipeline 350 inputs unlabeled data 210 (e.g., obtained from data source 206) to the autoencoder 300. The autoencoder 300 (e.g., the encoder) processes the unlabeled input data 210 (e.g., unlabeled images or unlabeled video frames) by compressing it into a lower-dimensional representation, often referred to as a “latent space” or “encoding,” which captures the essential features of the object appearing in the input data. The autoencoder 300 (e.g., the decoder) then takes an encoded representation and operates to generate a reconstructed image data 211 representing the original image 210. Accordingly, the autoencoder 300 learns to generate an output that closely resembles the input image, aiming to minimize the reconstruction error. During training, the autoencoder 300 adjusts its parameters to minimize the difference between the input image and the reconstructed image data 211, effectively learning a compressed representation that captures meaningful information. Accordingly, the autoencoder 300 learns to capture the most salient features of the data in its encoded representation. Once trained, the autoencoder 300 can extract features for downstream supervised tasks, without the need for labeled data.

The encoded representation 309 (e.g., encodings) produced by the autoencoder 300 can serve as a set of features that capture essential information from the input data 210. These encodings 309 can be used as input to the supervised depth estimation model 310 (e.g., implemented as a classifier model or regression model). In one or more non-limiting embodiments, the encodings 309 generated by the autoencoder 300 can be used for pretraining the supervised depth estimation model's initial layers. By fine-tuning the pretrained model on labeled data, the supervised depth estimation model 310 can learn to incorporate the encoded features 309 into its own representations. In one example, the supervised depth estimation model 310 can be trained according to the following operations: (1) if a label exists, directly optimize the depth estimation model 310 by the supervised loss; and (2) if label does not exist, optimize the depth estimation model 310 by reconstruction error.

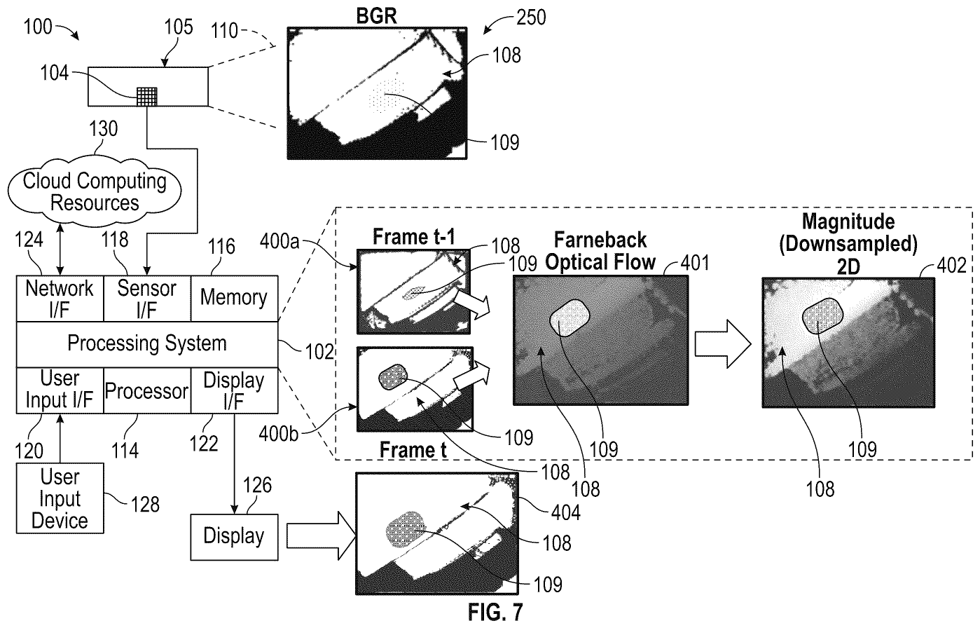

Turning now to FIG. 7, a computing system 100 configured to perform defect depth estimation based on an object 108 in motion is illustrated according to a non-limiting embodiment of the present disclosure. As described herein, the computing system 100 implements an optical instrument 105 that generates 2D monocular images and/or video frames without using a depth sensor. The optical instrument 105 includes an image sensor 104 (e.g., a borescope) that captures a real 2D video 250 of a moving object 108 (e.g., a turbine blade 108). The real 2D video 250 includes a plurality of sequentially captured frames (e.g., . . . . Frame 1, Frame t+1, Frame t+2, Frame t+3, . . . . Frame t+n), where each frame captures an instantaneous position and state of the moving object 108. The processing system 102 (e.g., included in imaging system 100 of FIG. 2) receives the real 2D video of a target object 108, and compare two different frames to one another to determine a depth of the defect 109. For example, the processing system 102 can compare a first frame (Frame t) captured at a first time stamp to a second frame (Frame 1−t) having a second time stamp (Frame t−1) earlier than the first frame. For example, the second frame (Frame t−1) can be the frame that directly precedes the first frame (Frame t).

In one or more non-limiting embodiments, the computing system 100 performs a Farneback optical flow analysis on the real 2D video to generate optical flow imagery 401, and then performs stereo imagery to down sampling the optical flow and generate a 3D stereo image 402. The optical flow analysis 401 compares two frames, e.g., two consecutive frames (Frame t−1 and Frame t), and monitors the same point or pixel on the object 108 in both frames (Frame t−1 and Frame t), and determines the displacement of one or more points as it moves from the first frame (Frame t−1) to the second frame (Frame 1). The displacement of the monitored point(s) generates a magnitude of the optical flow. The optical flow analysis is then converted into an optical flow magnitude map 402.

In one or more non-limiting embodiments, the computing system 100 monitors displacements of a defect as the object moves toward the camera in sequentially captured frames. For example, object, region and/or point displacements that occur closer to the image sensor 104 have a higher magnitude compared to displacements that occur further away from the image sensor 104. In one or more embodiments, the distance at which a point on the object (e.g., a point included in a defect) that is located away from the image sensor can define a depth. From the optical instrument's perspective, a point on the defect of the object 108 located further away from the image sensor 104 will change or displace less than a point on the defect located closer to the image sensor 104. Therefore, a monitored point that has a large displacement between two frames can be determined as having a greater depth than a monitored point having a smaller displacement between two frames.

In one or more non-limiting embodiment, experiments can be performed to map a measured displacement of a point between two frames to a measured known depth of defect (e.g., corrosion, oxidation, spallation). The experimental or measured results can then be stored in memory (e.g., memory 116). When performing a defect depth estimation test on a test object 108 captured in a real 2D video 250, the measured displacement of a point located on the defect 109 of the object 108 as it moves between two sequentially captured frames can be mapped to the measured results stored in the memory 116 to estimate the depth of the defect 109.

It should be appreciated that, although the invention is described hereinabove with regards to the inspection of only one type of object, it is contemplated that in other embodiments the invention may be used for various types of object inspection. The invention may be used for application specific tasks involving complex parts, scenes, etc. especially in smart factories.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Additionally, the invention may be embodied in the form of a computer or controller implemented processes. The invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire When implemented on a general-purpose microprocessor the computer program code segments may configure the microprocessor to create specific logic circuits.

Additionally, the processor may be part of a computing system that is configured to or adaptable to implement machine learning models which may include artificial neural networks, such as deep neural networks, convolutional neural networks, recurrent neural networks, vision transformers, encoders, decoders, or any other type of machine learning model. The machine learning models can be trained in a supervised, unsupervised, or hybrid manner.

While the present disclosure has been described with reference to an exemplary embodiment or embodiments, it will be understood by those skilled in the art that various changes may be made and equivalents may be substituted for elements thereof without departing from the scope of the present disclosure. Moreover, the embodiments or parts of the embodiments may be combined in whole or in part without departing from the scope of the invention. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this disclosure, but that the present disclosure will include all embodiments falling within the scope of the claims.

1. A defect depth estimation system comprising:
a training system configured to:
repeatedly receive a plurality of training image sets, each training image set comprising a first type of image having a first image format and capturing a target object having a defect, a second type of image having a second image format different from the first image format and capturing the target object having the defect, the second image data providing ground truth data indicating an actual depth of the defect,
wherein the first image format defines a first domain and the second image format defines a second domain different from the first domain such that the difference between the first domain and the second domain defines a domain gap; and
to perform at least one domain adaption technique on the first and second images that transforms the first domain and the second domain into a target third domain that reduces the domain gap;
to train a machine learning model to learn the actual depth of the defect using the first and second images having the target third domain;
an imaging system configured to receive a two-dimensional (2D) test image in the first format that captures a test object having an actual defect with an actual depth, to process the 2D test image using the trained machine learning model to determine an estimation of the actual depth of the actual defect, and to output from the trained machine learning model estimated depth information indicating the estimation of the actual depth.

2. The defect depth estimation system of claim 1, wherein the 2D test image is generated by an image sensor that captures the test object in real-time.

3. The defect depth estimation system of claim 2, wherein the 2D test image is captured by a borescope.

4. The defect depth estimation system of claim 1, wherein the first type of image is a two-dimensional (2D) video image and the second type of image is an ACI image.

5. The defect depth estimation system of claim 4, wherein the at least one domain adaption technique includes at least one of feature-based domain adaptation, instance-based domain adaptation, model-based domain adaptation, sub-space alignment, and Fourier domain adaptation (FDA).

6. The defect depth estimation system of claim 4, wherein the estimated depth information includes at least one of an estimated depth scalar value of the actual depth and an estimated depth map of the actual depth.

7-9. (canceled)

10. A defect depth estimation system comprising:
an image sensor configured to generate at least one 2D test image of a test object existing in real space and having a defect with a depth;
a processing system configured to input the at least one 2D test image to a trained machine learning model and to output estimated depth information indicating an estimation of the depth of the defect.

11. The defect depth estimation system comprising of claim 10, wherein the at least one 2D test image includes a 2D image frame included in a video stream captured by the image sensor.

12. The defect depth estimation system comprising of claim 10, wherein the at least one 2D test image includes a video stream containing movement of the test object, and wherein the processing system performs optical flow processing on the video stream to determine the estimated depth information of the defect.

13. The defect depth estimation system comprising of claim 12, wherein the optical flow processing includes:
comparing a first image frame included in the 2D video stream to a second image frame of the 2D video stream that precedes the first frame;
determining a change in a position of the defect as the second image frame transitions to the first image frame; and
determining the estimation of the depth based on the change in the position.

14. The defect depth estimation system of claim 10, wherein the estimated depth information includes at least one of an estimated depth scalar value of the actual depth and an estimated depth map of the actual depth.

15. The defect depth estimation system of claim 10, wherein the image sensor is a borescope.

16. A method to perform defect depth estimation from a monocular two-dimensional (2D) image without using a depth sensor, the method comprising:
repeatedly inputting a plurality of training image sets to a training system, each training image set comprising a first type of image having a first image format defining a first domain and capturing a target object having a defect, and a second type of image having a second image format different from the first image format and defining a second domain;
capturing, by the training system, the target object having the defect, the second image data providing ground truth data indicating an actual depth of the defect such that the difference between the first domain and the second domain defines a domain gap,
performing, by the training system, at least one domain adaption technique on the first and second images that transforms the first domain and the second domain into a target third domain that reduces the domain gap;
training, by the training system, a machine learning model to learn the actual depth of the defect using the first and second images having the target third domain;
inputting to an imaging system, a two-dimensional (2D) test image in the first format that captures a test object having an actual defect with an actual depth; and
processing, by the imaging system, the 2D test image using the trained machine learning model to determine an estimation of the actual depth of the actual defect, and to output from the trained machine learning model estimated depth information indicating the estimation of the actual depth.

17. The method of claim 16, wherein the 2D test image is generated by an image sensor that captures the test object in real-time.

18. The method of claim 17, wherein the 2D test image is captured by a borescope.

19. The method of claim 16, wherein the first type of image is a two-dimensional (2D) video image and the second type of image is an ACI image.

20. The method of claim 19, wherein the at least one domain adaption technique includes at least one of feature-based domain adaptation, instance-based domain adaptation, model-based domain adaptation, sub-space alignment, and Fourier domain adaptation (FDA).
